(19) United States
(12) Patent Application Publication
(10) Pub. No.: US 2011/0242812 A1
(43) Pub. Date: Oct. 6, 2011

(54) Lighting Device Having Enhanced Brightness

(76) Inventor: Ming-Tsai Wang, Dailiao Township (TW)

(21) Appl. No.: 12/754,821

(22) Filed: Apr. 6, 2010

(51) Int. Cl. F21S 4/00

(52) U.S. Cl. 362/249.06; 362/249.14

(57) ABSTRACT

A lighting device includes a plurality of light emitting members and a printed circuit board mounted in the main body and electrically connected to each of the light emitting members. The light emitting members are arranged on the printed circuit board in an annular manner to form at least one annular layer of light emitting members to prevent from incurring a concentration of heat radiation and to prevent from producing a greater heat so as to enhance the brightness and lifetime of the light emitting members.

### BACKGROUND OF THE INVENTION

1. Field of the Invention

The present invention relates to a lighting device and, more particularly, to a lighting device to provide a lighting effect.

2. Description of the Related Art

A conventional lighting device comprises a plurality of light emitting diodes to provide a lighting effect and a printed circuit board electrically connected to each of the light emitting members to actuate and control operation of the light emitting members. However, each of the light emitting diodes has a smaller brightness so that the lighting device needs to provide a larger number of light emitting diodes so as to enhance the brightness of the lighting device, thereby increasing the costs of fabrication. In addition, the light emitting diodes easily produce a greater heat and a concentration of heat radiation, thereby decreasing the working efficiency and lifetime of the lighting device.

### BRIEF SUMMARY OF THE INVENTION

In accordance with the present invention, there is provided a lighting device, comprising a plurality of light emitting members and a printed circuit board mounted in the main body and electrically connected to each of the light emitting members. The light emitting members are arranged on the printed circuit board in an annular manner.

The primary objective of the present invention is to provide a lighting device having a greater brightness.

Another objective of the present invention is to provide a lighting device having an enhanced lifetime.

A further objective of the present invention is to provide a lighting device, wherein the light emitting members are arranged on the printed circuit board in an annular manner to form at least one annular layer of light emitting members to prevent from incurring a concentration of heat radiation and to prevent from producing a greater heat so as to enhance the brightness and lifetime of the light emitting members.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lighting device in accordance with the preferred embodiment of the present invention.

FIG. 2 is a top view of a printed circuit board of the lighting device in accordance with the first preferred embodiment of the present invention.

FIG. 3 is a top view of a printed circuit board of the lighting device in accordance with the second preferred embodiment of the present invention.

FIG. 4 is a top view of a printed circuit board of the lighting device in accordance with the third preferred embodiment of the present invention.

### DETAILED DESCRIPTION OF THE INVENTION

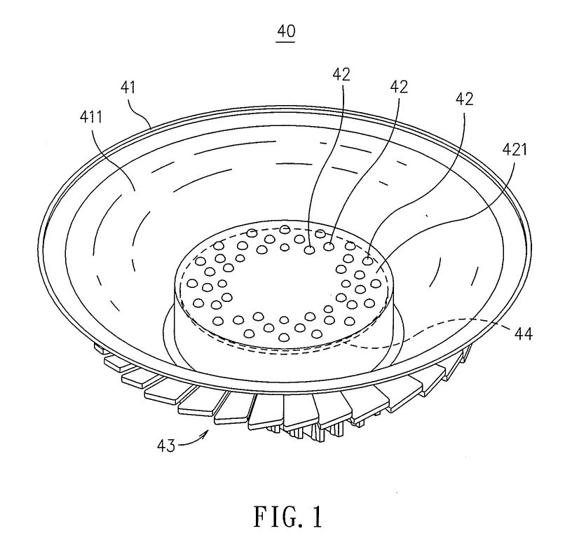

Referring to the drawings and initially to FIG. 1, a lighting device 40 in accordance with the preferred embodiment of the present invention comprises a main body 41, a plurality of light emitting members 42 mounted in the main body 41, a holder 421 mounted in the main body 41 to hold the light emitting members 42, a printed circuit board 44 mounted in the main body 41 and electrically connected to each of the light emitting members 42 to actuate and control operation of the light emitting members 42, a lens 411 mounted on the main body 41 to regulate a light emitting effect of the light emitting members 42, and a heat radiating unit 43 mounted on the main body 41 to provide a heat radiating effect to the light emitting members 42.

The printed circuit board 44 has a circular shape and is located in the holder 421. Each of the light emitting members 42 is made of a light emitting diode. The light emitting members 42 are arranged on the printed circuit board 44 in an annular manner. Thus, the light emitting members 42 are arranged on the printed circuit board 44 to form at least one annular layer of light emitting members 42. In the preferred embodiment of the present invention, the light emitting members 42 are arranged on the printed circuit board 44 to form three annular layers of light emitting members 42.

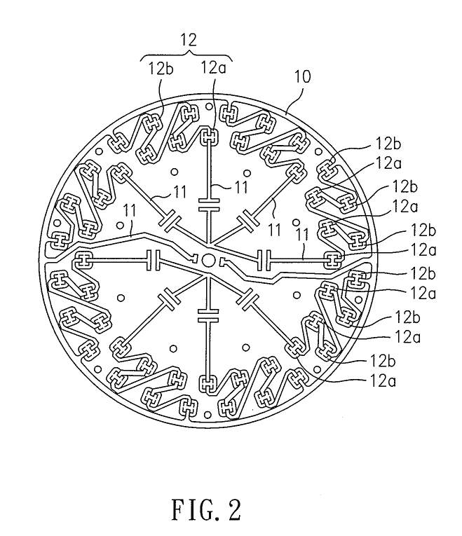

In practice, referring to FIG. 2 with reference to FIG. 1, the printed circuit board 10 (or 44) is provided with a plurality of circuits 11. Each of the circuits 11 includes a connecting unit 12 having a plurality of inner connecting points 12a and a plurality of outer connecting points 12b.

The inner connecting points 12a of the printed circuit board 10 are arranged on the printed circuit board 10 in an annular manner to form an inner annular layer, and the outer connecting points 12b of the printed circuit board 10 are arranged on the printed circuit board 10 in an annular manner to form an outer annular layer. The inner connecting points 12a and the outer connecting points 12b of the printed circuit board 10 are electrically connected to the light emitting members 42 respectively by soldering, so that the light emitting members 42 are arranged on the printed circuit board 10 in an annular manner to form an inner annular layer of light emitting members 42 and an outer annular layer of light emitting members 42.

The inner connecting points 12a and the outer connecting points 12b of the printed circuit board 10 are concentric with the printed circuit board 10 so that the inner annular layer of light emitting members 42 and the outer annular layer of light emitting members 42 are also concentric with the printed circuit board 10.

The inner connecting points 12a of the printed circuit board 10 has a number equal to that of the outer connecting points 12b of the printed circuit board 10 so that the inner annular layer of light emitting members 42 has a number equal to that of the outer annular layer of light emitting members 42. In the preferred embodiment of the present invention, the inner annular layer of light emitting members 42 has a number equal to twenty-four (24), and the outer annular layer of light emitting members 42 has a number equal to twenty-four (24).

The inner connecting points 12a of the printed circuit board 10 are equally spaced from each other so that the inner annular layer of light emitting members 42 are equally spaced from each other, and the outer connecting points 12b of the printed circuit board 10 equally spaced from each other so that the outer annular layer of light emitting members 42 are equally spaced from each other.

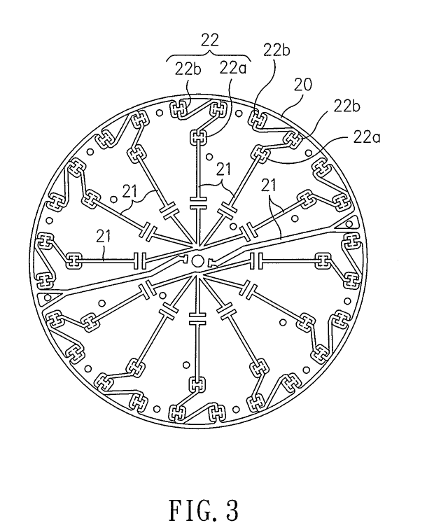

Alternatively, referring to FIG. 3 with reference to FIG. 1, the printed circuit board 20 (or 44) is provided with a plurality of circuits 21. Each of the circuits 21 includes a connecting unit 22 having a plurality of inner connecting points 22a and a plurality of outer connecting points 22b.

The inner connecting points 22a of the printed circuit board 20 are arranged on the printed circuit board 20 in an annular manner to form an inner annular layer, and the outer connecting points 22b of the printed circuit board 20 are arranged on the printed circuit board 20 in an annular manner to form an outer annular layer. The inner connecting points 22a and the outer connecting points 22b of the printed circuit board 20 are electrically connected to the light emitting members 42 respectively by soldering, so that the light emitting members 42 are arranged on the printed circuit board 20 in an annular manner to form an inner annular layer of light emitting members 42 and an outer annular layer of light emitting members 42.

The inner connecting points 22a and the outer connecting points 22b of the printed circuit board 20 are concentric with the printed circuit board 20 so that the inner annular layer of light emitting members 42 and the outer annular layer of light emitting members 42 are also concentric with the printed circuit board 20.

The inner connecting points 22a of the printed circuit board 20 has a number different from that of the outer connecting points 22b of the printed circuit board 20 so that the inner annular layer of light emitting members 42 has a number different from that of the outer annular layer of light emitting members 42. Preferably, the inner connecting points 22a of the printed circuit board 20 has a number smaller than that of the outer connecting points 22b of the printed circuit board 20 so that the inner annular layer of light emitting members 42 has a number smaller than that of the outer annular layer of light emitting members 42. In the preferred embodiment of the present invention, the inner annular layer of light emitting members 42 has a number equal to twelve (12), and the outer annular layer of light emitting members 42 has a number equal to twenty-four (24).

The inner connecting points 22a of the printed circuit board 20 are equally spaced from each other so that the inner annular layer of light emitting members 42 are equally spaced from each other, and the outer connecting points 22b of the printed circuit board 20 equally spaced from each other so that the outer annular layer of light emitting members 42 are equally spaced from each other.

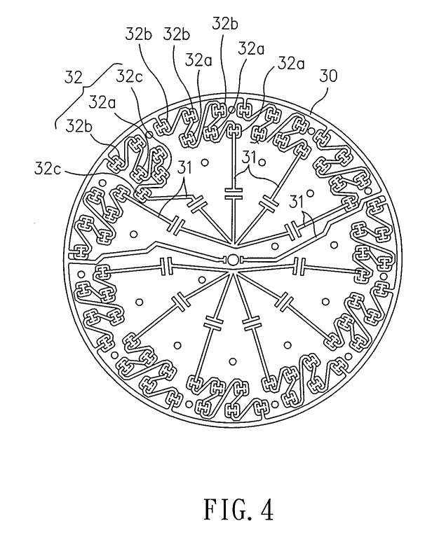

Alternatively, referring to FIG. 4 with reference to FIG. 1, the printed circuit board 30 (or 44) is provided with a plurality of circuits 31. Each of the circuits 31 includes a connecting unit 32 having a plurality of inner connecting points 32a and a plurality of outer connecting points 32b. The inner connecting points 32a of the printed circuit board 30 are additionally connected with a plurality of third connecting points 32c.

The inner connecting points 32a of the printed circuit board 30 are arranged on the printed circuit board 30 in an annular manner to form an inner annular layer, and the outer connecting points 32b of the printed circuit board 30 are arranged on the printed circuit board 30 in an annular manner to form an outer annular layer. The inner connecting points 32a and the outer connecting points 32b of the printed circuit board 30 are electrically connected to the light emitting members 42 respectively by soldering, so that the light emitting members 42 are arranged on the printed circuit board 30 in an annular manner to form an inner annular layer of light emitting members 42 and an outer annular layer of light emitting members 42. In addition, the third connecting points 32c of the printed circuit board 30 are electrically connected to the light emitting members 42 respectively by soldering, so that the light emitting members 42 are arranged on the printed circuit board 30 to form a third layer of light emitting members 42 additionally.

The inner connecting points 32a and the outer connecting points 32b of the printed circuit board 30 are concentric with the printed circuit board 30 so that the inner annular layer of light emitting members 42 and the outer annular layer of light emitting members 42 are also concentric with the printed circuit board 30.

The inner connecting points 32a of the printed circuit board 30 has a number equal to that of the outer connecting points 32b of the printed circuit board 30 so that the inner annular layer of light emitting members 42 has a number equal to that of the outer annular layer of light emitting members 42. In the preferred embodiment of the present invention, the inner annular layer of light emitting members 42 has a number equal to thirty-two (32), and the outer annular layer of light emitting members 42 has a number equal to thirty-two (32).

The inner connecting points 32a of the printed circuit board 30 are equally spaced from each other so that the inner annular layer of light emitting members 42 are equally spaced from each other, and the outer connecting points 32b of the printed circuit board 30 equally spaced from each other so that the outer annular layer of light emitting members 42 are equally spaced from each other.

Accordingly, the light emitting members 42 are arranged on the printed circuit board 44 (10, 20 or 30) in an annular manner to form at least one annular layer of light emitting members 42 to prevent from incurring a concentration of heat radiation and to prevent from producing a greater heat so as to enhance the brightness and lifetime of the light emitting members 42.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lighting device, comprising:
a plurality of light emitting members;
a printed circuit board mounted in the main body and electrically connected to each of the light emitting members;
wherein the light emitting members are arranged on the printed circuit board in an annular manner.

2. The lighting device of claim 1, wherein the light emitting members are arranged on the printed circuit board to form at least one annular layer of light emitting members.

3. The lighting device of claim 1, wherein the light emitting members are arranged on the printed circuit board to form an inner annular layer of light emitting members and an outer annular layer of light emitting members.

4. The lighting device of claim 3, wherein the inner annular layer of light emitting members and the outer annular layer of light emitting members are concentric with the printed circuit board.

5. The lighting device of claim 3, wherein the inner annular layer of light emitting members has a number equal to that of the outer annular layer of light emitting members.

6. The lighting device of claim 3, wherein the inner annular layer of light emitting members are equally spaced from each other.

7. The lighting device of claim 3, wherein the outer annular layer of light emitting members are equally spaced from each other.

8. The lighting device of claim 3, wherein the inner annular layer of light emitting members has a number different from that of the outer annular layer of light emitting members.

9. The lighting device of claim 8, wherein the inner annular layer of light emitting members has a number smaller than that of the outer annular layer of light emitting members.

10. The lighting device of claim 3, wherein the light emitting members are arranged on the printed circuit board to form a third layer of light emitting members additionally.

11. The lighting device of claim 1, wherein the light emitting members are equally spaced from each other.

12. The lighting device of claim 1, wherein the light emitting members are concentric with the printed circuit board.

13. The lighting device of claim 1, wherein some of the light emitting members are equally spaced from each other, and some of the light emitting members are non-equally spaced from each other.

14. The lighting device of claim 1, wherein the printed circuit board has a circular shape.

15. The lighting device of claim 1, wherein the light emitting members are arranged on the printed circuit board to form three annular layers of light emitting members.

16. The lighting device of claim 1, wherein each of the light emitting members is made of a light emitting diode.
